(19) United States
(12) Patent Application Publication
(10) Pub. No.: US 2019/0251202 A1
(43) Pub. Date: Aug. 15, 2019

(54) SMART RECIPE RECOMMENDATION APPARATUS, METHOD THEREOF AND AUTOMATIC COOKING APPARATUS

(71) Applicant: CHEF Automation Co. Ltd., Taipei City (TW)

(72) Inventor: Kai-Chi Chang, New Taipei City (TW)

(73) Assignee: CHEF Automation Co. Ltd., Taipei City (TW)

(21) Appl. No.: 15/986,830

(22) Filed: May 23, 2018

(30) Foreign Application Priority Data
Feb. 12, 2018 (CN) 201810144630.4

(51) Int. Cl. G06F 17/30

(52) U.S. Cl. CPC G06F 17/30702; G06F 17/30663

(57) ABSTRACT

A smart recipe recommendation apparatus, a method thereof, and an automatic cooking apparatus are provided. In the method, recipe variants in recipes are updated in real time, where the recipe variants are related to adjustable content, e.g., ingredient parameters, in each recipe. Next, search indicators inputted by a user are obtained, where the search indicators are related to preferences for the recipes. The recipes are screened and sorted according to the search indicators. Screened and sorted results of the recipes are provided. Accordingly, the ingredient parameters (e.g., ingredient names, amounts, shapes, etc.) and a cooking procedure in the recipe can be adaptively modified, and the user can obtain the best recipe content any time upon inquiry, so as to complete the cooking successfully.

### CROSS-REFERENCE TO RELATED APPLICATION

This application claims the priority benefit of China application serial no. 201810144630.4, filed on Feb. 12, 2018. The entirety of the above-mentioned patent application is hereby incorporated by reference herein and made a part of this specification.

### BACKGROUND OF THE INVENTION

### Field of the Invention

The disclosure relates to a smart analysis technique, and in particular, to a smart recipe recommendation apparatus, a method thereof, and an automatic cooking apparatus.

### Description of Related Art

In recent years, food safety problems have occurred frequently. Many people will now consider cooking at home so that they can monitor food ingredients and flavoring additives. A housewife can generally handle ten to twenty dishes by heart, but may need to refer to recipes provided by other people to complete other dishes. Moreover, as more and more exotic food restaurants are available, people become readier to accept exotic foods and are willing to taste them at home. Domestic dishes themselves may total well over thousands of types, and foreign dishes are even innumerable. Ordinary people can hardly handle all dishes according to several cookbooks, and it is even harder to find a recipe that matches preferences or requirements at the moment.

On the other hand, recipes usually describe required ingredients, amounts, and handling procedures for each dish. However, chances are that people may not be able to obtain certain ingredients at the moment, or the purchased ingredients may not be those prescribed in the recipe, so that the dish cannot be completed, or the cooked result is inconsistent with the recipe.

### SUMMARY OF THE INVENTION

The embodiments of the invention provide a smart recipe recommendation apparatus, a method thereof, and an automatic cooking apparatus that integrate big data and update recipe variants in real time according to the latest external information to allow people to easily obtain a recipe that matches preferences at the moment.

The smart recipe recommendation method according to an embodiment of the invention includes the following steps. Recipe variants in recipes are updated in real time, wherein the recipe variants are related to adjustable content of each of the recipes. A search indicator is obtained, wherein the search indicator is related to preferences for the recipes. The recipes are screened and sorted according to the search indicator. Screened and sorted results of recipes are provided.

In an embodiment of the invention, updating the recipe variants in the recipes in real time includes the following step. Content of the recipes is updated according to external information. The external information is related to the recipe variants. The recipe variants include at least one ingredient variant. Each ingredient variant includes one or a combination of a place of origin of an ingredient, seasonality, a purchase price, quality, and a carbon footprint. The content of each of the recipes includes ingredient parameters and a cooking procedure.

In an embodiment of the invention, the ingredient variant is recorded in an ingredient variable database, and updating the content of the recipes according to the external information includes the following step. Data in the ingredient variable database is updated any time according to the external information.

In an embodiment of the invention, screening and sorting the recipes according to the search indicator includes the following step. Whether the search indicator is an unquantifiable variable is sequentially determined. If the search indicator is the unquantifiable variable, recipes that do not match the search indicator are excluded.

In an embodiment of the invention, after whether the search indicator is the unquantifiable variable is determined, the method further includes the following step.

If the search indicator is not the unquantifiable variable, a weight corresponding to the search indicator is obtained.

In an embodiment of the invention, after whether the search indicator is the unquantifiable variable is determined, the method further includes the following steps. Degrees of match of the recipes are calculated according to the weight corresponding to the search indicator to obtain match scores of the recipes. The recipes are sorted according to the match scores of the recipes.

In an embodiment of the invention, the weight corresponding to the search indicator is equal, is prioritized, or is defined through an input operation.

In an embodiment of the invention, obtaining the search indicator includes the following steps. A current location and a current time are obtained. The ingredient parameters in the recipes are screened according to the current location and the current time.

In an embodiment of the invention, after the screened and sorted results of the recipes are provided, the method further includes the following steps. A post-search indicator is obtained, wherein the post-search indicator is related to preferences for the recipes. The recipes in the screened and sorted results are screened and sorted according to the post-search indicator. Screened and sorted results of recipes are provided.

In an embodiment of the invention, before the at least one search indicator is obtained, the method further includes the following steps. A user interface including input options for the search indicator is provided. An input operation corresponding to the search indicator performed on the user interface is received.

The smart recipe recommendation apparatus according to an embodiment of the invention includes a storage device and a processor coupled to the storage device. The storage device records recipes. The processor updates recipe variants in the recipes in real time, obtains a search indicator, screens and sorts the recipes according to the search indicator, and provides screened and sorted results of the recipes. The recipe variants are related to adjustable content of each of the recipes, and the search indicator is related to preferences for the recipes.

In an embodiment of the invention, the smart recipe recommendation apparatus further includes a communication transceiver coupled to the processor. The communication transceiver receives external information. The external information is related to the recipe variants. The recipe variants include ingredient variants. Each of the ingredient variants includes one or a combination of a place of origin of an ingredient, seasonality, a purchase price, quality, and a carbon footprint. The processor updates content of the recipes according to the external information. The content of each of the recipes includes ingredient parameters and a cooking procedure.

In an embodiment of the invention, the storage device includes an ingredient variable database recording the ingredient variants. The processor updates data in the ingredient variable database any time according to the external information obtained via the communication transceiver.

In an embodiment of the invention, the processor sequentially determines whether the search indicator is an unquantifiable variable. If the search indicator is the unquantifiable variable, the processor excludes recipes that do not match the search indicator.

In an embodiment of the invention, the storage device further records a weight corresponding to the search indicator. If the search indicator is not the unquantifiable variable, the processor obtains the weight corresponding to the search indicator.

In an embodiment of the invention, the processor calculates degrees of match of the recipes according to the weight corresponding to the search indicator to obtain match scores of the recipes and sorts the recipes according to the match scores of the recipes.

In an embodiment of the invention, the weight corresponding to the search indicator is equal, is prioritized, or is defined through an input operation.

In an embodiment of the invention, the processor obtains a current location and a current time and screens the ingredient parameters in the recipes according to the current location and the current time.

In an embodiment of the invention, the processor obtains a post-search indicator, screens and sorts the recipes in the screened and sorted results according to the post-search indicator, and provides screened and sorted results of the recipes. The post-search indicator is related to preferences for the recipes.

In an embodiment of the invention, the smart recipe recommendation apparatus further includes a display and an input device coupled to the processor. The display displays a user interface including input options for the search indicator. The input device receives an input operation corresponding to the search indicator performed on the user interface.

The automatic cooking apparatus according to an embodiment of the invention includes automatic cooking appliances, a storage device, and a processor. The automatic cooking appliances perform cooking operations through mechanical components of the automatic cooking appliances. The storage device records recipes. The processor is coupled to the automatic cooking appliances and the storage device. The processor updates recipe variants in the recipes in real time, obtains a search indicator, screens and sorts the recipes according to the search indicator, provides screened and sorted results of the recipes, obtains a decided content on the recipes in the screened and sorted results, and performs the cooking operations through the automatic cooking appliances according to the decided content. The recipe variants are related to adjustable content of each of the recipes, and the search indicator is related to preferences for the recipes.

Accordingly, in the smart recipe recommendation apparatus, the method thereof, and the automatic cooking apparatus of the embodiments of the invention, the ingredient variable database is updated with the latest external information in real time to adaptively adjust the ingredient parameters (e.g., the ingredient names, amounts, shapes, components, etc.) and the cooking procedure in the recipe, so that the user can obtain the best recipe content any time upon inquiry and successfully complete the cooking. Moreover, as a large number of recipes are available, the embodiments of the invention further provide better screened and sorted results according to the user's preferences for the user to choose from. On the other hand, the automatic cooking apparatus is operated with the automatic cooking appliances to avoid human errors and is especially suitable for modern people who are too busy to cook.

To provide a further understanding of the aforementioned and other features and advantages of the disclosure, exemplary embodiments, together with the reference drawings, are described in detail below.

### BRIEF DESCRIPTION OF THE DRAWINGS

FIG. 1 is a component block diagram illustrating a smart recipe recommendation apparatus according to an embodiment of the invention.

FIG. 2 is a flowchart illustrating a smart recipe recommendation method according to an embodiment of the invention.

FIG. 3 is a schematic diagram illustrating recipe-related parameters according to an embodiment of the invention.

FIG. 4 is a flowchart illustrating a screening procedure according to an embodiment of the invention.

FIG. 5 is a functional block diagram illustrating an automatic cooking apparatus according to an embodiment of the invention.

### DESCRIPTION OF THE EMBODIMENTS

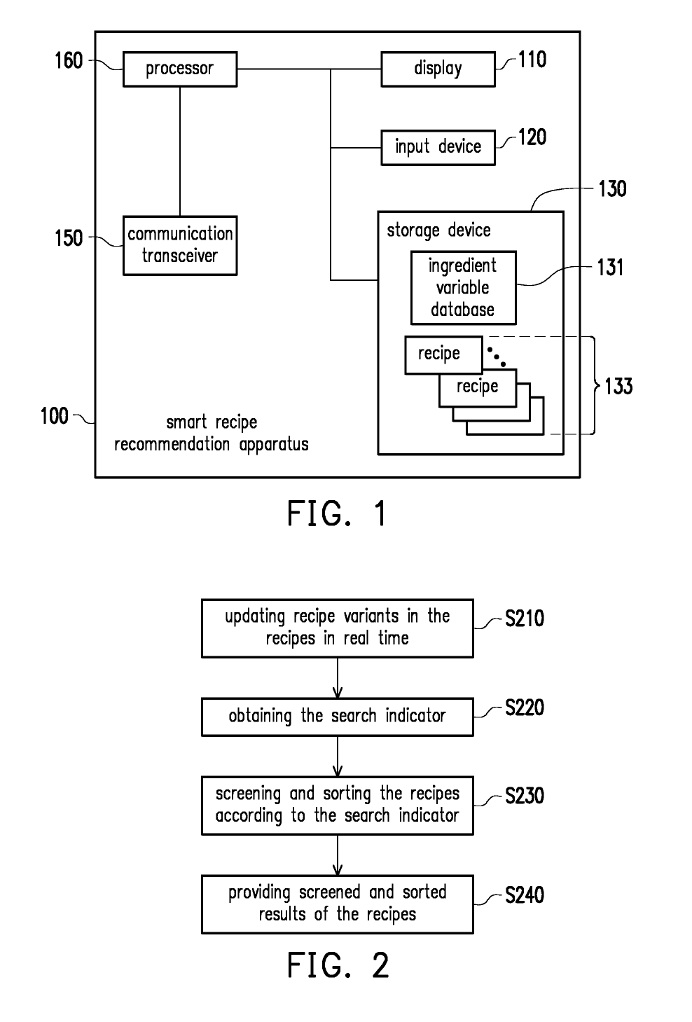

FIG. 1 is a component block diagram illustrating a smart recipe recommendation apparatus 100 according to an embodiment of the invention. Referring to FIG. 1, the smart recipe recommendation apparatus 100 includes a display 110, an input device 120, a storage device 130, a communication transceiver 150, and a processor 160 but is not limited hereto. The smart recipe recommendation apparatus 100 may be a device such as a smartphone, a tablet computer, a computer host, a server, and a workstation.

The display 110 may be a display panel of various display types, such as LCD and LED. The input device 120 may be a device, such as a mouse, a touch panel, a keyboard, and a button, capable of receiving a user input operation.

The storage device 130 may be a fixed or movable random access memory (RAM), read-only memory (ROM), flash memory, hard disk drive, solid-state drive of any form or a similar device and is configured to record information, data, and files of various types including applications, an ingredient variable database 131, recipes 133 from various countries, parameters corresponding to recipes, weights corresponding to search indicators, match scores, etc. The stored contents and their applications will be described in the embodiments below.

The communication transceiver 150 may be a transceiver supporting communication technologies such as 3G/4G mobile communication, Wi-Fi, Ethernet, and optical fiber networks and is configured to receive or transmit data via the Internet or internal networks.

The processor 160 is coupled to the display 110, the input device 120, the storage device 130, and the communication transceiver 150, and the processor 160 may be a central processing unit (CPU), a programmable microprocessor for general or specific purposes, a digital signal processor (DSP), a programmable controller, an application specific integrated circuit (ASIC), another similar device, or a combination of the devices above. In the present embodiment, the processor 160 is configured to execute all operations of the smart recipe recommendation apparatus 100.

It is noted that the electronic components of the present embodiment are formed in an integral device. However, in other embodiments, the electronic components may be separately formed on several devices, and information is transmitted via corresponding communication transceivers. For example, the display 110 and the input device 120 may be provided in a smartphone, and the processor 160 and the storage device 130 may be provided in a server.

To facilitate comprehension of operation procedures of the invention, multiple embodiments are described in detail below. In the description below, a method of the present embodiment is described with reference to the components in FIG. 1. Referring to FIG. 2, which is a flowchart illustrating a smart recipe recommendation method according to an embodiment of the invention. The procedures of the method of the present embodiment may be adjusted according to implementation requirements and are not limited hereto.

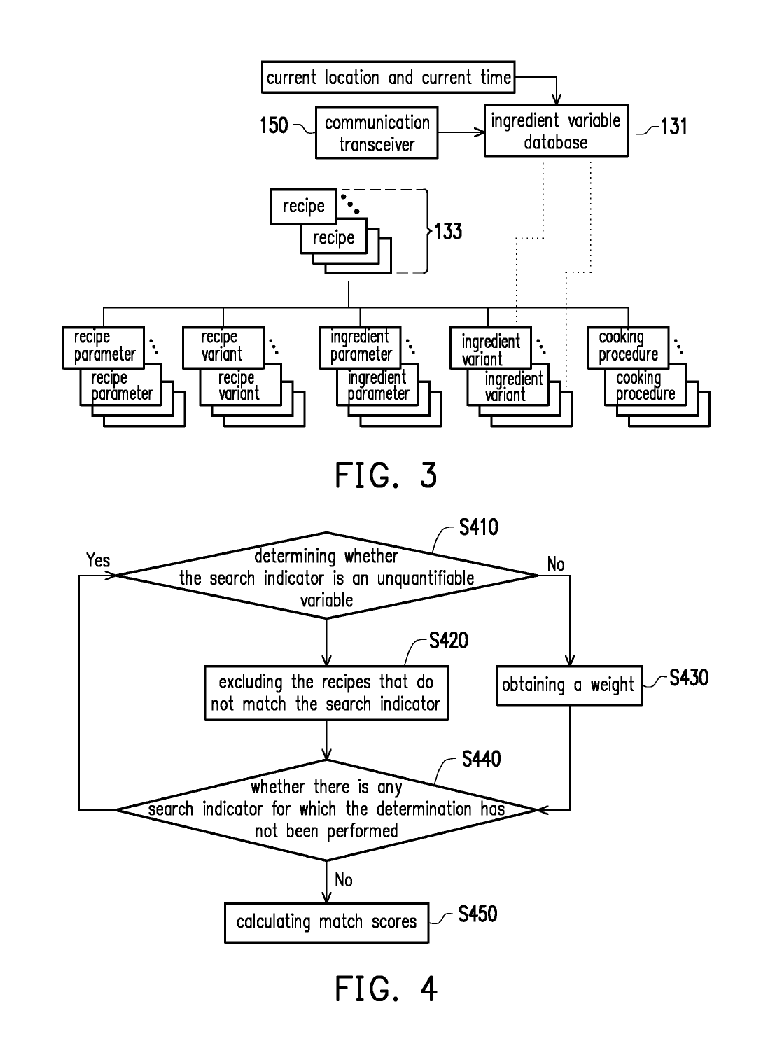

The processor 160 updates recipe variants in the recipes 133 recorded in the storage device 150 in real time (step S210). Referring to FIG. 3, the processor 160 receives external information at predetermined times or any time from specific websites, databases, or servers via the communication transceiver 150. The external information is related to the recipe variants, and the recipe variants are adjustable content of each of the recipes 133. In the present embodiment, the recipe variant is a total set of one or more ingredient variants, and the ingredient variants are recorded in the ingredient variable database 131. The ingredient variant may be one or a combination of a place of origin of an ingredient, seasonality, a purchase price, quality, and a carbon footprint. It is noted that the present embodiment takes into account that the place of origin and seasonality of each food ingredient may be different, and the place of origin and seasonality may affect conditions including the purchase price and quality. Moreover, with the rise of environmental awareness, the carbon footprint is also one of the considerations for a consumer to choose a food ingredient. The processor 160 updates data in the ingredient variable database 131 any time according to the external information obtained via the communication transceiver 150, such that the recipe variants all correspond to the latest external information.

On the other hand, ingredient parameters (including ingredient names, amounts, shapes, affecting components, ingredient preparation time, etc.) and a cooking procedure (i.e., cooking steps) may need to be adjusted due to changes in the updated ingredient variants (e.g., adding the amount by 20%, putting the ingredient after boiling water instead, etc.). Therefore, the processor 160 further updates the content (i.e., the ingredient parameters and the cooking procedure) of the recipes 133 or even provides options of alternative ingredients according to the obtained external information. In addition, the processor 160 also obtains a current location and a current time and screens the ingredient parameters in the recipes 133 according to the current location and the current time to exclude food ingredients that do not match in terms of the season, the place of origin, etc. Accordingly, the most suitable recipe content can be provided after comprehensive consideration.

Next, the processor 160 displays a user interface via the display 110. The user interface includes input options (e.g., columns, lists, and menus) for search indicators. The search indicator is related to a user's preferences for the recipes 133 (e.g., low-calorie, fast, Italian, etc.). It is noted that parameter content of the recipes 133 may include dish names, dish series, dish classification, ingredient names, dish portions, dish calories, cooking difficulties, ingredient preparation time, cooking time, nutritional information, cooking methods, cooking appliances, textures, flavors, etc. The user interface may directly provide options of corresponding content as reference for inputting the search indicator, or provide blank fields open for input or even commands of specific rules, which are not limited in the embodiments of the invention. On the other hand, the processor 160 simultaneously receives an input operation or command corresponding to the search indicator inputted by the user on the user interface via the input device 120, such that the processor 160 obtains the inputted search indicator (step S220).

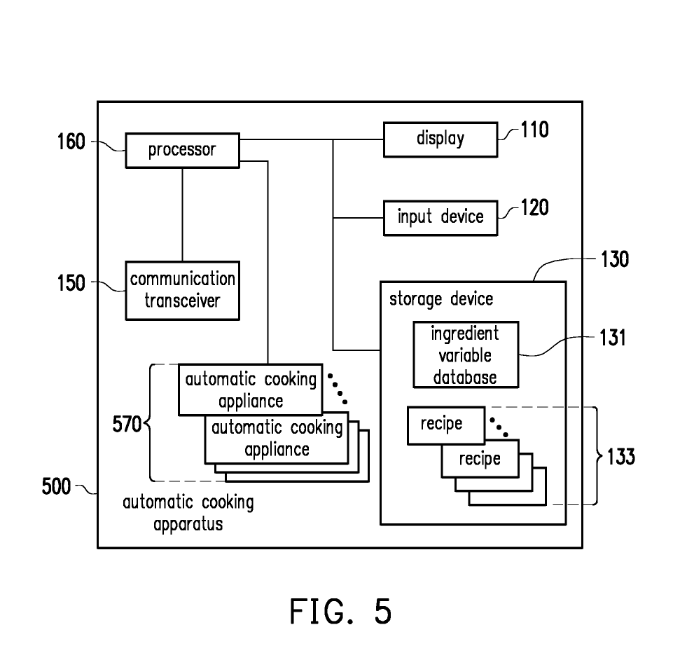

Then, the processor 160 can screen and sort the recipes according to the search indicator (step S230). Referring to FIG. 4, which is a flowchart illustrating a screening procedure according to an embodiment of the invention. The processor 160 sequentially determines whether the inputted search indicator is an unquantifiable variable (step S410). An unquantifiable variable (e.g., a shrimp, a cast iron wok, and Russian) is a content that cannot be quantified by numbers. Conversely, a quantifiable variable (e.g., a calorie value, a time, an amount, a price, seasonality, and a distance from the place of origin) is a content that can be quantified by numbers. If a search indicator is an unquantifiable variable, the processor 160 may directly exclude the recipes 133 that do not match the search indicator (step S420). For example, if the search indicator is “vegetarian”, the processor 160 excludes the recipes 133 that contain meat ingredients. On the other hand, if a search indicator is not an unquantifiable variable (namely, is a quantifiable variable), the processor 160 obtains a weight corresponding to the search indicator (step S430). Weights corresponding to the search indicators may be all or partially equal, may be prioritized, or may be defined by the user's input operation received via the input device 120.

Next, the processor 160 determines whether there is still any search indicator for which the unquantifiable variable determination has not been performed (step S440). If affirmative, returning to step S410. If negative (namely, the determination of step S410 has been performed for all of the inputted search indicators), the processor 160 calculates degrees of match (or referred to as relevance) of the recipes 133 with the search indicator according to the weights corresponding to the search indicators (e.g., a degree of match between a weight of portion and the dish portion in the recipes 133, a degree of match between a weight of time and the cooking time in the recipes 133, etc.) to obtain match scores of each of the recipes 133 (for example, by adding the degrees of match between each of the parameter contents and the corresponding weights in each of the recipes 133) (step S450) and sort the recipes 133 according to the match scores of the recipes 133. For example, the processor 160 sorts the match scores in a descending order, or merely obtains three highest match scores. Then, the processor 160 provides screened and sorted results of the recipes 133 (step S240). For example, the screened and sorted results are presented by the display 110. After the input device 120 receives the user's selection operation on a specific recipe 133 in the screened and sorted results, the processor 160 displays detailed content of the selected recipe 133 via the display 110.

It is noted that if there are excessive screened and sorted results or the user suddenly thinks of an additional search indicator, the processor 160 may further obtain a post-search indicator via the input device 120. The post-search indicator represents preferences for the recipes 133 in a next round. Based on the procedure of FIG. 4, the processor 160 screens and sorts the recipes 133 in the screened and sorted results generated in step S240 according to the post-search indicator and can provide screened and sorted results of the recipes 133 of the second round. It is noted that the present embodiment may further provide searches of a third round, a fourth round, or further rounds to allow the user to select the recipe 133 that best matches his/her preferences. Moreover, when the search indicator inputted in the previous round is erroneous, the user interface further provides icons for returning or deleting the inputted search indicator to allow the user to modify the search indicators any time in a desired manner.

On the other hand, people generally prepare two to three courses for a meal, and it may be necessary to prepare five courses or more during festivities. A total number of the food ingredients may well be more than ten for each meal, and it is inconvenient for people to write down the ingredient names. Accordingly, the processor 160 may receive selection operations (e.g., selecting or dragging to a storage list) on the recipes in the screened and sorted results of the first round, the second round, or even further rounds via the input device 120, and generate a shopping list including the ingredient names according to the ingredient names in the recipes corresponding to the selection operations. The shopping list may include the ingredient names, current prices, amounts, sizes, weights, etc., and part of the information may be obtained by consulting relevant web pages or servers via the communication transceiver 150. In addition, the processor 160 may further obtain information including web page links, prices, and price comparisons for the ingredient names on shopping websites via the communication transceiver 150 and present contents of the shopping list along with shopping web pages via the display 110 for people to directly purchase food ingredients online.

The embodiments of the invention further provide an automatic cooking apparatus to assist people who are not good at cooking or are too busy to cook. Referring to FIG. 5, which is a functional block diagram illustrating an automatic cooking apparatus 500 according to an embodiment of the invention. The automatic cooking apparatus 500 includes a display 110, an input device 120, a storage device 130, a communication transceiver 150, a processor 160, and one or more automatic cooking appliances 570 but is not limited hereto.

Reference may be made to descriptions of FIGS. 1 to 4 above for relevant descriptions of the components of the same numerals in the automatic cooking apparatus 500, which shall not be repeatedly described here. The automatic cooking appliance 570 may be an automatic cooking appliance such as an automatic rice cooker, an automatic stir fry wok, a water oven, and an oven and is operated with mechanical components such as a robotic arm and an automatic turntable to complete cooking operations (e.g., cutting, steaming, washing, flip flying, etc.) on the food ingredients.

After step S240 of FIG. 4 above, the processor 160 obtains a decided content (e.g., selecting the specific recipe 133) of the user on the recipes 133 in the screened and sorted results via the input device 120 and performs the cooking operations according to the decided content through the automatic cooking appliances 570. The recipe 133 records the ingredient parameters including the ingredient names, the amounts, etc. and the cooking procedure for processing the food ingredients and operating the appliances. The processor 160 converts the foregoing data into commands compatible with the automatic cooking appliances 570 to have the automatic cooking appliances 570 to complete the cooking operations according to the recorded content in the recipe 133 (i.e., performing a specific cooking procedure on the food ingredients).

In summary of the above, in the smart recipe recommendation apparatus, the method thereof, and the automatic cooking apparatus of the embodiments of the invention, the ingredient variable database is updated with the latest external information in real time to adaptively adjust the ingredient parameters (e.g., the ingredient names, amounts, shapes, components, etc.) and the cooking procedure (steps) in the recipe, so that the user can obtain the best recipe content any time he/she consults the recipe and successfully complete the cooking without selecting food ingredients of undesirable conditions (e.g., food ingredients that are not in season or are expensive). Moreover, as a large number of recipes are available, the embodiments of the invention further provide better screened and sorted results according to the user's preferences. In other words, the user can obtain suitable recommended recipes after inputting several key conditions. On the other hand, the automatic cooking apparatus is operated with the automatic cooking appliances to avoid human errors and save time and is especially suitable for people who are too busy to cook or not good at cooking.

Although the invention is disclosed as the embodiments above, the embodiments are not meant to limit the invention. Any person skilled in the art may make slight modifications and variations without departing from the spirit and scope of the invention. Therefore, the protection scope of the invention shall be defined by the claims attached below.

What is claimed is:

1. A smart recipe recommendation method comprising:
updating recipe variants in a plurality of recipes in real time, wherein the recipe variants are related to adjustable content of each of the recipes;
obtaining at least one search indicator, wherein the at least one search indicator is related to preferences for the recipes;
screening and sorting the recipes according to the at least one search indicator; and
providing screened and sorted results of the recipes.

2. The smart recipe recommendation method according to claim 1, wherein the step of updating the recipe variants in the recipes in real time comprises:
updating content of the recipes according to at least one piece of external information, wherein the at least one piece of external information is related to the recipe variants, the recipe variants comprise at least one ingredient variant, each ingredient variant comprises one or a combination of a place of origin of an ingredient, seasonality, a purchase price, quality, and a carbon footprint, and the content of each of the recipes comprises a plurality of ingredient parameters and a cooking procedure.

3. The smart recipe recommendation method according to claim 2, wherein the at least one ingredient variant is recorded in an ingredient variable database, and the step of updating the content of the recipes according to the at least one piece of external information comprises:
updating data in the ingredient variable database any time according to the at least one piece of external information.

4. The smart recipe recommendation method according to claim 1, wherein the step of screening and sorting the recipes according to the at least one search indicator comprises:
sequentially determining whether the at least one search indicator is an unquantifiable variable; and
excluding recipes that do not match the at least one search indicator if the at least one search indicator is the unquantifiable variable.

5. The smart recipe recommendation method according to claim 4, wherein after determining whether the at least one search indicator is the unquantifiable variable, the method further comprises:
obtaining a weight corresponding to the at least one search indicator if the at least one search indicator is not the unquantifiable variable.

6. The smart recipe recommendation method according to claim 5, wherein after sequentially determining whether the at least one search indicator is the unquantifiable variable, the method further comprises:
calculating degrees of match of the recipes according to the weight corresponding to the at least one search indicator to obtain match scores of the recipes; and
sorting the recipes according to the match scores of the recipes.

7. The smart recipe recommendation method according to claim 5, wherein the weight corresponding to the at least one search indicator is equal, is prioritized, or is defined through an input operation.

8. The smart recipe recommendation method according to claim 1, wherein the step of obtaining the at least one search indicator comprises:
obtaining a current location and a current time; and
screening the ingredient parameters in the recipes according to the current location and the current time.

9. The smart recipe recommendation method according to claim 1, wherein after providing the screened and sorted results of the recipes, the method further comprises:
obtaining at least one post-search indicator, wherein the at least one post-search indicator is related to preferences for the recipes;
screening and sorting the recipes in the screened and sorted results according to the at least one post-search indicator; and
providing screened and sorted results of the recipes.

10. The smart recipe recommendation method according to claim 9, wherein after providing the screened and sorted results of the recipes, the method further comprises:
receiving a selection operation on the recipes in the screened and sorted results; and
generating a shopping list comprising a plurality of ingredient names according to the ingredient names in the recipe corresponding to the selection operation.

11. The smart recipe recommendation method according to claim 1, wherein before obtaining the at least one search indicator, the method further comprises:
providing a user interface comprising input options for the at least one search indicator; and
receiving an input operation corresponding to the at least one search indicator performed on the user interface.

12. A smart recipe recommendation apparatus comprising:
a storage device recording a plurality of recipes; and
a processor coupled to the storage device, wherein the processor updates recipe variants in the recipes in real time, obtains at least one search indicator, screens and sorts the recipes according to the at least one search indicator, and provides screened and sorted results of the recipes, wherein the recipe variants are related to adjustable content of each of the recipes, and the at least one search indicator is related to preferences for the recipes.

13. The smart recipe recommendation apparatus according to claim 12, further comprising:
a communication transceiver coupled to the processor and receiving at least one piece of external information, wherein the at least one piece of external information is related to the recipe variants, the recipe variants comprise at least one ingredient variant, and each ingredient variant comprises one or a combination of a place of origin of an ingredient, seasonality, a purchase price, quality, and a carbon footprint,
wherein the processor updates content of the recipes according to the at least one piece of external information, and the content of each of the recipes comprises a plurality of ingredient parameters and a cooking procedure.

14. The smart recipe recommendation apparatus according to claim 13, wherein the storage device comprises an ingredient variable database recording the at least one ingredient variant, and the processor updates data in the ingredient variable database any time according to the at least one piece of external information obtained via the communication transceiver.

15. The smart recipe recommendation apparatus according to claim 12, wherein the processor sequentially determines whether the at least one search indicator is an unquantifiable variable, and if the at least one search indicator is the unquantifiable variable, the processor excludes recipes that do not match the at least one search indicator.

16. The smart recipe recommendation apparatus according to claim 15, wherein the storage device further records a weight corresponding to the at least one search indicator, and if the at least one search indicator is not the unquantifiable variable, the processor obtains the weight corresponding to the at least one search indicator.

17. The smart recipe recommendation apparatus according to claim 16, wherein the processor calculates degrees of match of the recipes according to the weight corresponding to the at least one search indicator to obtain match scores of the recipes, and sorts the recipes according to the match scores of the recipes.

18. The smart recipe recommendation apparatus according to claim 16, wherein the weight corresponding to the at least one search indicator is equal, is prioritized, or is defined through an input operation.

19. The smart recipe recommendation apparatus according to claim 12, wherein the processor obtains a current location and a current time and screens the ingredient parameters in the recipes according to the current location and the current time.

20. The smart recipe recommendation apparatus according to claim 12, wherein the processor obtains at least one post-search indicator, screens and sorts the recipes in the screened and sorted results according to the at least one post-search indicator, and provides screened and sorted results of the recipes, wherein the at least one post-search indicator is related to preferences for the recipes.

21. The smart recipe recommendation apparatus according to claim 20, further comprising:
an input device coupled to the processor and receiving a selection operation on the recipes in the screened and sorted results,
wherein the processor generates a shopping list comprising a plurality of ingredient names according to the ingredient names in the recipe corresponding to the selection operation.

22. The smart recipe recommendation apparatus according to claim 12, further comprising:
a display coupled to the processor and displaying a user interface comprising input options for the at least one search indicator; and
an input device coupled to the processor and receiving an input operation corresponding to the at least one search indicator performed on the user interface.

23. An automatic cooking apparatus comprising:
a plurality of automatic cooking appliances performing cooking operations through mechanical components of the automatic cooking appliances;
a storage device recording a plurality of recipes; and
a processor coupled to the automatic cooking appliances and the storage device, wherein the processor updates recipe variants in the recipes in real time, obtains at least one search indicator, screens and sorts the recipes according to the at least one search indicator, provides screened and sorted results of the recipes, obtains a decided content on the recipes in the screened and sorted results, and performs the cooking operations through the automatic cooking appliances according to the decided content, wherein the recipe variants are related to adjustable content of each of the recipes, and the at least one search indicator is related to preferences for the recipes.
